(19) United States
(12) Patent Application Publication
(10) Pub. No.: US 2014/0047688 A1
(43) Pub. Date: Feb. 20, 2014

(54) PULLER

(71) Applicant: Tina CHEN, Taichung City (TW)

(72) Inventor: Tina CHEN, Taichung City (TW)

(21) Appl. No.: 13/589,152

(22) Filed: Aug. 19, 2012

(51) Int. Cl. B23P 19/04

(52) U.S. Cl. 29/256

(57) ABSTRACT

A puller includes a main body, a plurality of hook elements, a plurality of connecting rods, and an operating rod. The main body has a threaded hole and a plurality extending arms, and each extending arm has an abutting trough at an end. Each hook element has at least one claw portion. Two opposite ends of each connecting rod are pivotably connected with one of the hook elements and one of the extending arms. The operating rod has threaded rod screwed with the threaded hole. When the hook element abuts against one of the abutting trough, the extending arm covers at least half the hook element in width to position it. Thereby, durability and stability are improved.

### BACKGROUND OF THE INVENTION

1. Field of the Invention

The present invention relates to a puller, more specifically to a puller with improved structure strength.

2. Description of the Prior Art

A puller is widely used for removing workpieces. A typical puller comprises a main body, a plurality of hook elements, a plurality of connecting rods and an operating rod. The main body has a threaded hole and a plurality of extending portions. Each hook element has a claw. Two opposite ends of each connecting rod are pivotably connected with one of the extending portions and one of the hook elements respectively. The operating rod has an abutting portion adapted for abutting against a workpiece and an operating portion at two opposite ends respectively. The operating rod further has a threaded rod portion between the abutting portion and the operating portion, and the threaded rod portion is screwed with the threaded hole. When the operating portion is rotated, the operating rod rotates and moves with respect to the main body so that portion to be removed of the workpiece is pulled and removed by the claws.

However, the puller mentioned above is disadvantageous in many aspects. First, when the operating rod is rotated, the hook element abuts against a free end of the extending portion to increase friction. In addition, due to the large torque, the hook element and main body encounter a strong shearing force. Thus, operation efficiency is low, and the components may be damaged. Second, the hook elements, the connecting rods, and the main body are able to pivot freely with respect to each other so that the hook elements tend to droop inward. Thereby, before positioning the hook elements to the workpiece, it is inconvenient that a user has to pull the hook elements outward first. Also, hook elements which swing freely result dangers.

On the other hand, the distance between the hook elements is fixed, so a conventional puller is unable to adapted for removing workpieces in different sizes.

The present invention is, therefore, arisen to obviate or at least mitigate the above mentioned disadvantages.

### SUMMARY OF THE INVENTION

The main object of the present invention is to provide a puller having improved structure strength and stability, and the distance between hook elements can be adjusted.

To achieve the above and other objects, a puller of the present invention includes a main body, a plurality of hook elements, and an operating rod.

The main body has a threaded hole and a plurality of extending arms which extend toward different directions. Each extending arm has a first pivot portion and an abutting portion. The abutting portion is located at a free end of the extending arm and includes an abutting trough. Each abutting trough has a positioning mechanism.

Each hook element has at least one claw portion and a second pivot portion. The claw portion is located at a terminal end of the hook portion. More preferably, each hook element has two claw portions at two opposite ends of the hook element respectively. In addition, the second pivot portion includes a first pivot hole and a second pivot hole which are arranged along a longitudinal direction of the hook element.

Two opposite ends of each connecting rod are pivotably connected with one of the first pivot portions and one of the second pivot portions.

When each hook element abuts against one of the abutting troughs, the extending arm covers at least half the hook element in width, and a positioning portion of the hook element is positioned by the positioning mechanism so that the hook element is unable to leave the abutting trough freely.

The operating rod has an operating end and an abutting end at two opposite ends respectively, and further has a threaded rod between the operating end and the abutting end. The threaded rod is screwed with the threaded hole of the main body.

Thereby, when operating, each hook element is restricted by the abutting trough so that stability and durability are both improved. In addition, the hook elements can be operated in various lengths and directions to accommodate with different situations.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of the present invention;

FIG. 2 is an illustration of the present invention;

FIG. 3 is a partial breakdown drawing of the present invention;

FIGS. 4 and 5 are illustrations of operation of the present invention;

FIGS. 6 and 7 are partial lateral views of the present invention;

FIG. 7A is a partial profile of FIG. 7;

FIG. 8 is a lateral view showing another embodiment of the present invention.

### DETAILED DESCRIPTION OF THE PREFERRED EMBODIMENTS

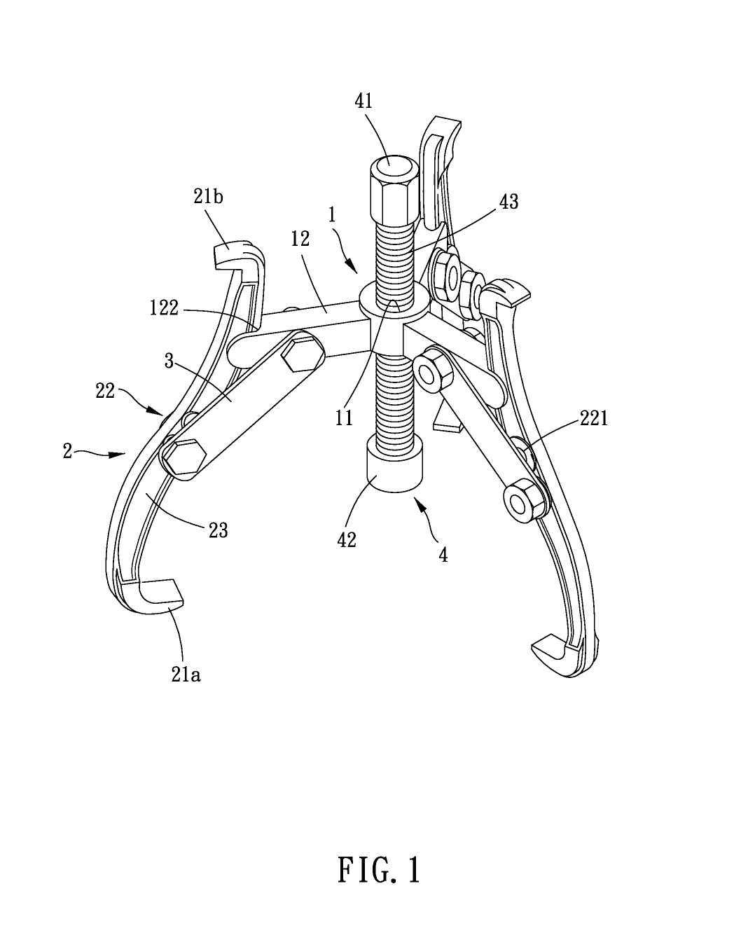

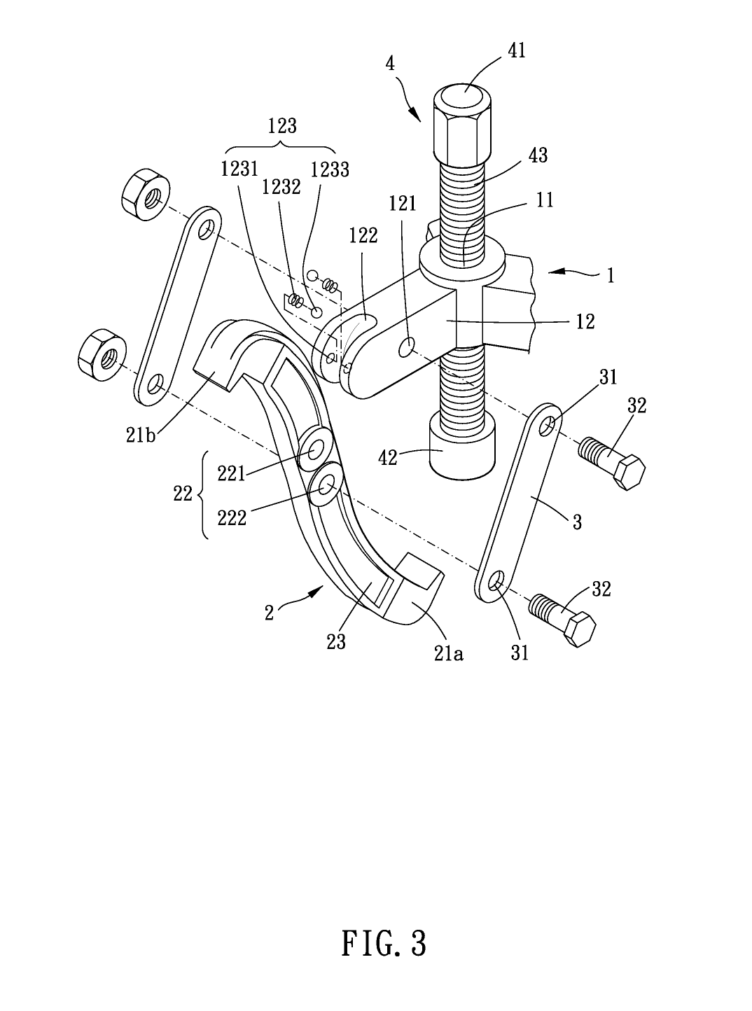

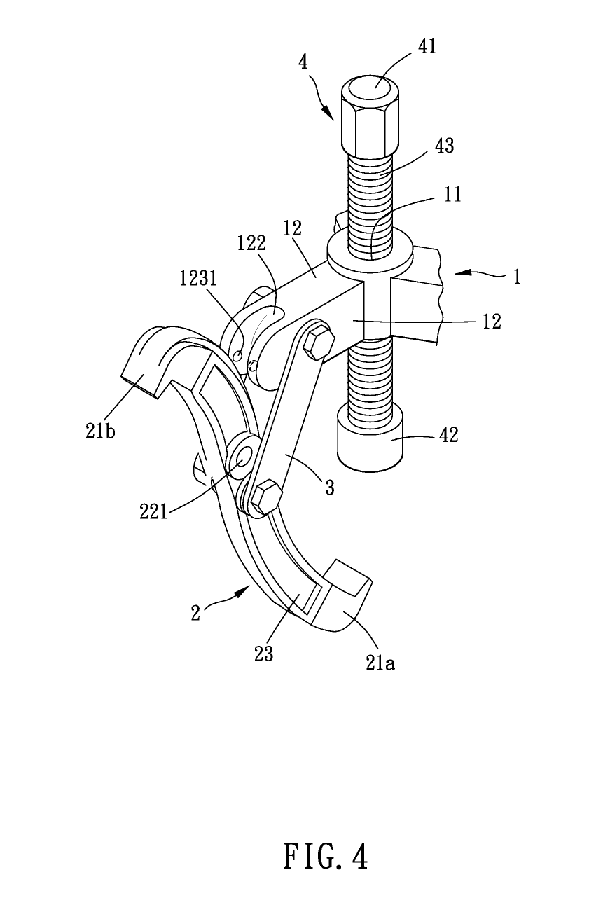

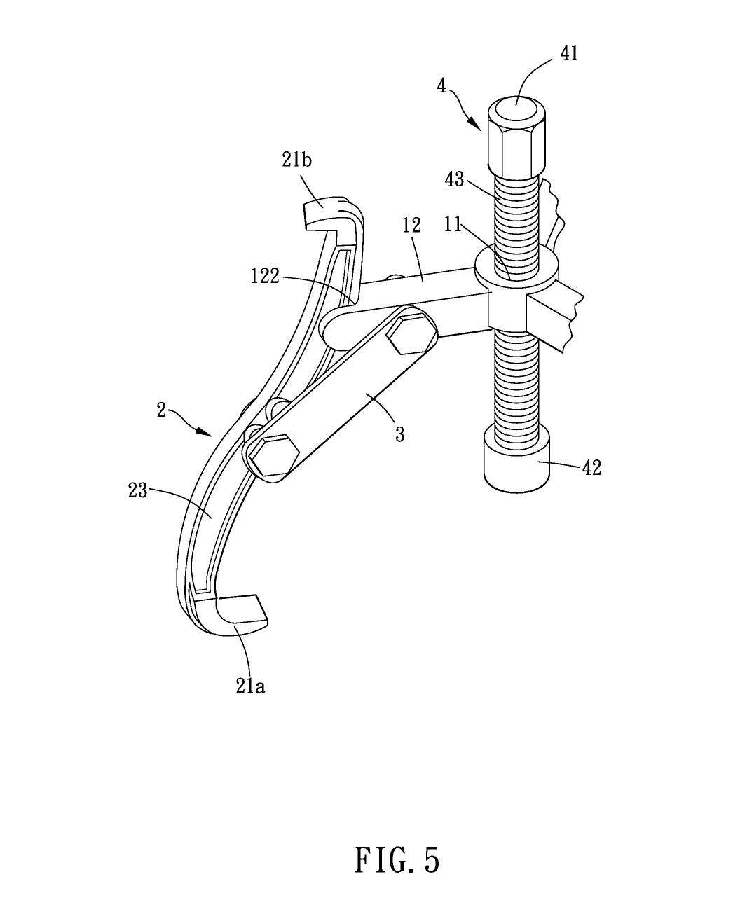

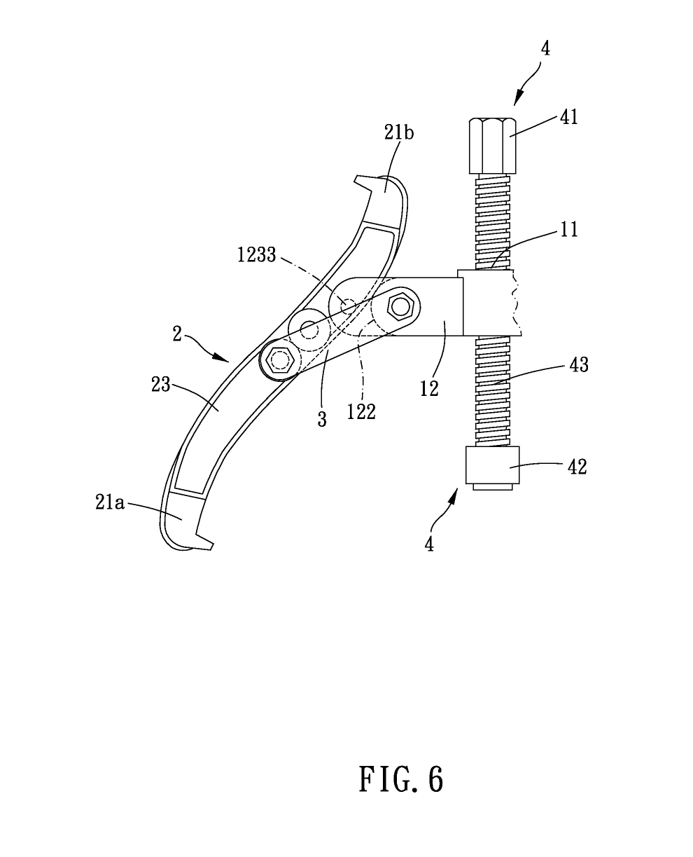

Please refer to FIG. 1 to FIG. 7 and FIG. 7A, the puller of the present embodiment includes a main body 1, a plurality of hook elements 2, a plurality of connecting rods 3, and an operating rod 4.

The main body 1 has a threaded hole 11 and a plurality of extending arms 12. The threaded hole 11 is located at a center of the main body 1, and the extending arms 12 radially extend from the threaded hole 11. Each extending arm 12 has a first pivot portion and an abutting portion. The first pivot portion includes a joint hole 121. The abutting portion is located at a free end of the extending arm 12 and includes an abutting trough 122. Each abutting trough 122 has a positioning mechanism 123. In the major embodiment, the positioning mechanism 123 includes a receiving hole 1231, an elastic element 1232, and a positioning bead 1233. The positioning bead 1233 has an external diameter larger than an internal diameter of the receiving hole 1231. The elastic element 1232 and the positioning bead 1233 are received in the receiving hole 1231, and the elastic element 1232 is located between and abuts against a bottom of the receiving hole 1231 and the positioning bead 1233 so that the positioning bead 1233 has a tendency to move toward the abutting trough 122.

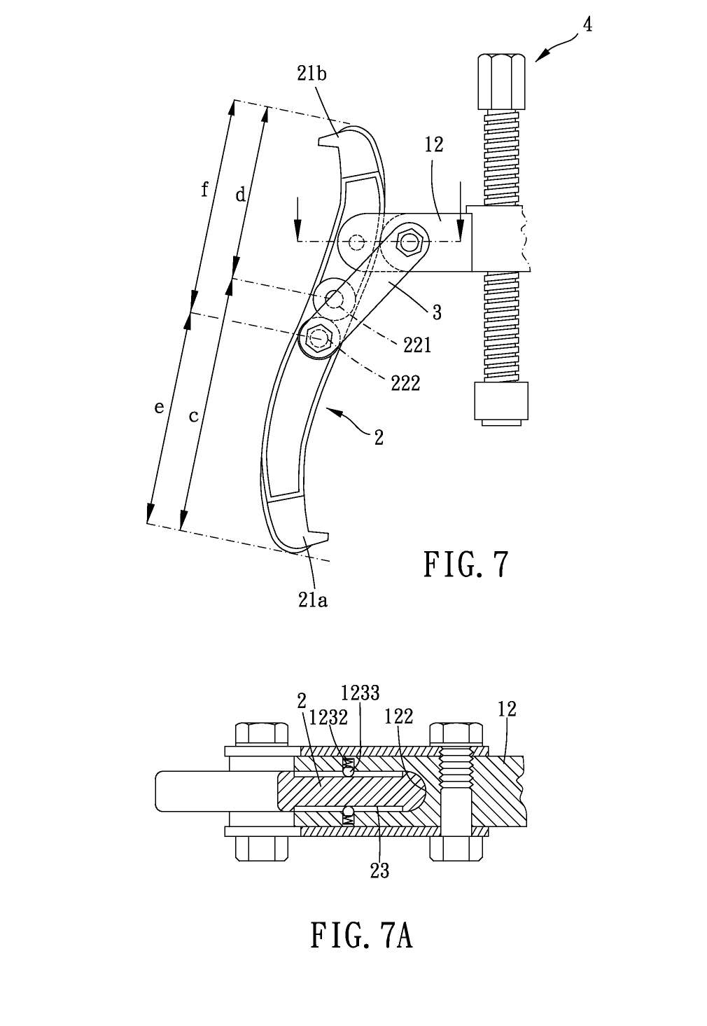

Each hook element 2 has at least one claw portion and a second pivot portion 22. The claw portion is located at a terminal end of the hook element 2. The second pivot portion 22 includes a first pivot hole 221 and a second pivot hole 222 which are arranged along a longitudinal direction of the hook element 2. A distance between the first pivot hole 221 and the claw portion is defined as a, and a distance between the second pivot hole 222 and the claw portion is defined as b, wherein a and b are different from each other. In the major embodiment, each hook element 2 has two claw portions 21a,21b located at two opposite ends of the hook element 2, and the two claw portions 21a,21b extend toward two opposite sides of the hook element 2. A distance from the first pivot hole 221 to the two claw portions 21a,21b are defined as c and d respectively, and a distance from the second pivot hole 222 to the two claw portions 21a,21b are defined as e and f respectively, wherein c, d, e, f are different from each other, as shown in FIG. 7.

Two opposite ends of each connecting rod 3 are pivotably connected with one of the first pivot portions and one of the second pivot portions 22 respectively. More specifically, each of the two opposite ends of the connecting rod 3 forms a connecting hole 31. Each connecting hole 31 and one of the joint hole 121, the first pivot hole 221, and the second pivot hole 222 are inserted by a pivot element 32 so that the connecting rod 3 is able to pivot with respect to the extending arm 12 and the hook element 2.

The operating rod 4 has an operating end 41 and an abutting end 42 at two opposite ends respectively, and further has a threaded rod 43 between the operating end 41 and the abutting end 42. The threaded rod 43 is screwed with the threaded hole 11 of the main body 1. In the major embodiment, the operating end 41 has a polygonal shape to be adapted for a driving tool such as a wrench, and the abutting end 42 is adapted for abutting against a fixed portion 51 of a workpiece 5.

When each hook element 2 abuts against one of the abutting trough 122, the corresponding extending arm 12 covers at least half the hook element 2 in width, and a positioning portion of the hook element 2 is positioned by the positioning mechanism 123 so that the hook element 2 is unable to leave the abutting trough 122 freely. More preferably, the positioning portion is a recess 23 formed on a lateral surface of the hook element 2 to be abutted against by the positioning bead 1233, wherein the recess 23 extends along the longitudinal direction of the hook element 2.

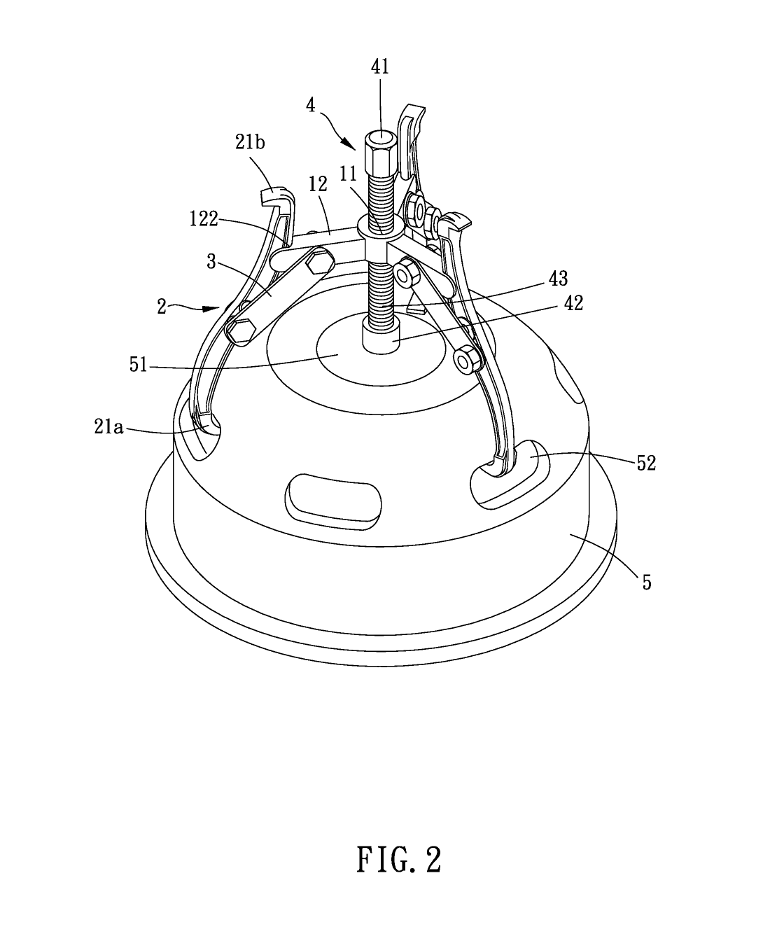

During operation, as shown in FIG. 2, the abutting end 42 of the operating rod 4 abuts against the fixed portion 51 of the workpiece 5, and the claw portions 21a hook on a portion to be removed 52 of the workpiece 5. When the operating end 41 is rotated, the threaded rod 43 rotates and moves with respect to the threaded hole 11, and then the portion to be removed 52 of the workpiece 5 is pulled by the claw portions 21a from the fixed portion 51.

In addition, the main body encounters a very large torque, more especially when the workpiece is tough to be removed. To prevent twisting of the main body and the hook elements, the abutting trough with positioning mechanism of the present invention can keep the abutting hook element stable. Moreover, lateral walls of the abutting trough can further drive the hook elements to rotate simultaneously, and the positioning mechanism further increases stability to prevent hook elements from swinging and improves safety.

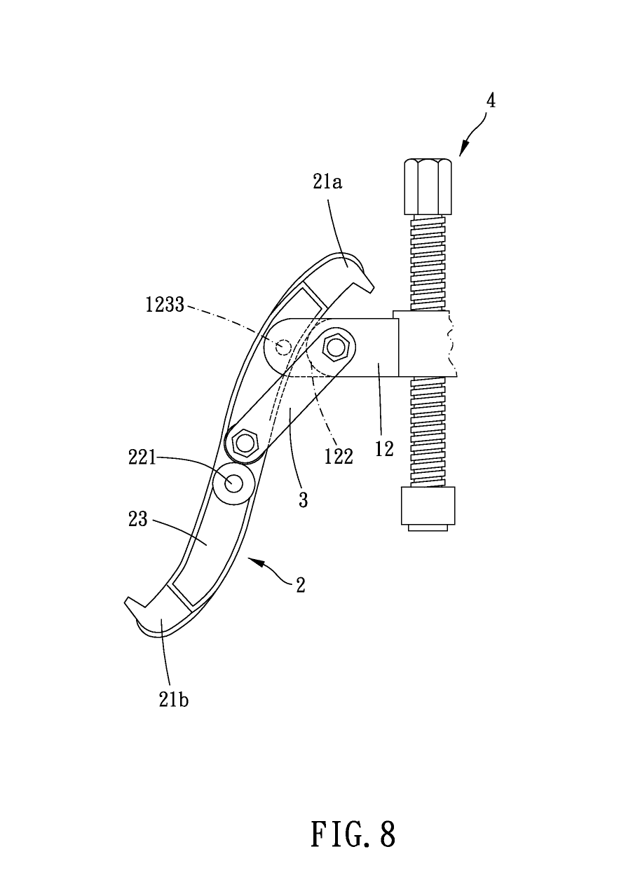

Besides, due to the two pivot holes of each hook element and different distances from the pivot holes to the claw portions, four different operating sizes can be provided when different pivot holes and different claw portion are selected. Thereby, the puller of the present invention can be employed in workpieces in various sizes. Furthermore, hooking direction of the hook elements can be changed as inward or outward, as shown in FIG. 8, to hook on ring-shaped or disk-shaped workpieces.

In conclusion, the puller of the present invention is easy to operate due to the simple structure, and improves stability and durability to raise efficiency and safety. In addition, the puller of the present invention provides various operating lengths and angles.

What is claimed is:

1. A puller, including:
a main body, having a threaded hole and a plurality of extending arms, each extending arm having a first pivot portion and an abutting portion, the abutting portion being located at a free end of the extending arm and including an abutting trough;
a plurality of hook elements, each hook element having at least one claw portion and a second pivot portion, the claw portion being located at a terminal end of the hook element;
a plurality of connecting rods, two opposite ends of each connecting rod being pivotably connected with one of the first pivot portions and one of the second pivot portions respectively;
an operating rod, having an operating end and an abutting end at two opposite ends respectively, a threaded rod being formed between the operating end and the abutting end, the threaded rod being screwed with the threaded hole of the main body;
wherein the abutting trough is adapted for being abutted against by one of the hook elements.

2. The puller of claim 1, wherein each abutting trough has a positioning mechanism, a positioning portion of one of hook elements is positioned by the positioning mechanism when the hook element abuts against the abutting trough so that the hook element is unable to leave the abutting trough freely.

3. The puller of claim 2, wherein the positioning mechanism includes a receiving hole, an elastic element, and a positioning bead, the positioning bead has an external diameter larger than an internal diameter of the receiving hole, the elastic element and the positioning bead are received in the receiving hole, the elastic element is located between and abuts against a bottom of the receiving hole and the positioning bead so that the positioning bead tends to move toward the abutting trough, the positioning portion of the hook element is a recess adapted for being abutted against by the positioning bead.

4. The puller of claim 1, wherein each hook element has two claw portions located at two opposite ends of the hook element, the claw portions extend toward two different sides of the hook element.

5. The puller of claim 1, wherein the second pivot portion of each hook element includes a first pivot hole and a second pivot hole, the first pivot hole and the second pivot hole are arranged along a longitudinal direction of the hook element.

6. The puller of claim 5, wherein a distance between the first pivot hole of each hook element and the claw portion of the hook element is defined as a, a distance between the second pivot hole of each hook element and the claw portion of the hook element is defined as b, a and b are different from each other.

7. The puller of claim 4, wherein the second pivot portion of each hook element includes a first pivot hole and a second pivot hole, the first pivot hole and the second pivot hole are arranged along a longitudinal direction of the hook element.

8. The puller of claim 7, wherein distances from the first pivot hole of each hook element to the two claw portions of the hook element are defined as c and d respectively, distances from the second pivot hole of each hook element to the two claw portions of the hook element are defined as e and f respectively, c, d, e, and f are different from each other.

9. The puller of claim 1, wherein when each hook element abuts against one of the abutting troughs, the corresponding extending arm covers at least half the hook element in width.
